(19) United States
(12) Patent Application Publication
(10) Pub. No.: US 2026/0260640 A1
(43) Pub. Date: Sep. 3, 2026

(54) Wind-responsive furniture with integrated airflow-actuated acoustic elements

(71) Applicant: Evgeniya Tseitlin, The Woodlands, TX (US)

(72) Inventor: Evgeniya Tseitlin, The Woodlands, TX (US)

(21) Appl. No.: 19/553,403

(22) Filed: Mar. 1, 2026

Related U.S. Application Data
(60) Provisional application No. 63/765,664, filed on Mar. 2, 2025.

(51) Int. Cl. G10K 1/10; A47B 7/00; A47B 13/00; A47B 37/04; A47B 97/00; G10K 1/26

(52) U.S. Cl. CPC G10K 1/10; A47B 13/00; A47B 37/04; A47B 97/00; G10K 1/26; A47B 7/00; A47B 2200/0084; A47B 2220/0061

(57) ABSTRACT

A wind-responsive furniture assembly includes a structural frame configured to support functional loads and at least one acoustic element structurally supported by and mechanically coupled to the structural frame. The acoustic element is positioned relative to the structural frame such that airflow interacting with the structural frame induces multidirectional movement of the acoustic element relative to the structural frame. Movement of the acoustic element relative to the structural frame produces audible sound through mechanical interaction. The furniture assembly thereby functions both as a load-bearing structure and as a passive airflow-actuated acoustic system.

### CROSS-REFERENCE TO RELATED APPLICATIONS

This application claims the benefit of U.S. Provisional Patent Application No. 63/765,664, filed Mar. 2, 2025, entitled “Wind-Responsive Outdoor Furniture With Integrated Musical Bell System,” the disclosure of which is incorporated herein by reference in its entirety pursuant to 35 U.S.C. § 119(e).

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX

Not Applicable.

### BACKGROUND OF THE INVENTION

The present invention relates to wind-responsive furniture assemblies incorporating airflow-actuated acoustic elements. More particularly, the invention relates to load-bearing furniture structures configured such that airflow interacting with the furniture induces mechanical movement of structurally integrated acoustic elements to produce audible sound.

Sound-producing devices such as bells and chimes are conventionally suspended from architectural structures or independent supports separate from furniture assemblies. Such devices are not incorporated into the structural framework of load-bearing furniture.

Conventional furniture assemblies are configured to provide structural support and static functional utility. Such assemblies do not incorporate structurally integrated acoustic mechanisms configured to convert airflow-induced mechanical movement into controlled audible output through components integrated into the load-bearing frame. There remains a need for furniture configured to function as both a structural support assembly and a passive airflow-actuated acoustic system integrated into the load-bearing frame.

### BRIEF SUMMARY OF THE INVENTION

The present invention provides wind-responsive furniture incorporating structurally integrated airflow-actuated acoustic elements forming part of a load-bearing structural frame assembly.

In one embodiment, the furniture assembly includes a structural frame configured to support functional loads and comprising a supporting base structure and an upper structural portion positioned in spaced relation to define a structural space within which at least one acoustic element is incorporated.

At least one suspension member is formed as an integral structural feature of the structural frame assembly during manufacture of the furniture assembly.

At least one acoustic element is mechanically coupled to the suspension member and positioned within the structural space in a manner permitting oscillatory movement relative to the structural frame assembly.

Airflow interacting with the furniture assembly induces multidirectional mechanical movement of the acoustic element within the structural space, and such movement generates audible sound through impact, resonance, vibration, striker activation, or other mechanical interaction.

The acoustic element and suspension member are permanently integrated into the structural frame assembly such that the sound-producing mechanism forms part of the load-bearing architecture of the furniture assembly and operates passively in response to airflow without requiring electrical components, motors, or external actuation systems.

### BRIEF DESCRIPTION OF THE DRAWINGS

FIG. 1 illustrates an isometric view of the furniture assembly including a supporting base structure (101), an acoustic element (102), an upper structural portion (103), and a suspension member (105).

FIG. 2 illustrates a side view of the furniture assembly including the supporting base structure (101), the upper structural portion (103), the suspension member (105), the acoustic element (102). Airflow is illustrated by a schematic directional arrow (104) indicating the direction of air movement relative to the furniture assembly.

FIG. 2A is an enlarged detail of FIG. 2 illustrating the acoustic element (102) mechanically coupled to the upper structural portion (103) by the suspension member (105). Curved directional arrows represent multidirectional oscillatory movement in response to airflow. Airflow is illustrated by a schematic directional arrow (104) indicating the direction of air movement relative to the furniture assembly.

FIG. 3 illustrates an exploded view of the supporting base structure (101), the upper structural portion (103), the suspension member (105), and the acoustic element (102).

### DETAILED DESCRIPTION OF THE INVENTION

As used herein, the term “structural space” refers to a structurally bounded region defined by load-bearing members of the furniture assembly, the region being dimensioned and configured as part of the structural design to accommodate and permit multidirectional oscillatory movement of at least one acoustic element positioned therein while maintaining load-bearing stability of the frame.

The structural space is at least partially open to ambient airflow such that airflow can enter, traverse, and exit the region defined by the load-bearing members, thereby interacting with the acoustic element positioned within the structural space. The geometry of the load-bearing members defines boundaries of the structural space while permitting airflow exposure sufficient to induce oscillatory movement.

Airflow interacting with the furniture assembly may include natural wind or other relative air movement. In the drawings, airflow direction is illustrated schematically by directional arrows (104).

As used herein, the term “acoustic element” (102) refers to any body positioned within the furniture assembly that is capable of generating audible sound through mechanical movement relative to the structural components of the furniture assembly in response to airflow interaction. Acoustic elements include, without limitation, bells, tubular chimes, cylindrical or other resonant bodies, metallic impact members, ceramic acoustic bodies, composite sound-producing structures, internally striker-activated bells, or equivalent airflow-responsive sound-producing devices.

The acoustic element may be fabricated from metal, metal alloys, wood, ceramic, composite materials, polymers, or other sound-producing materials.

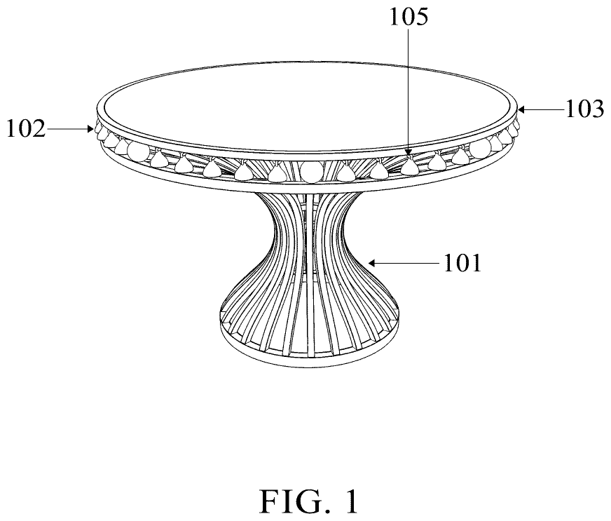

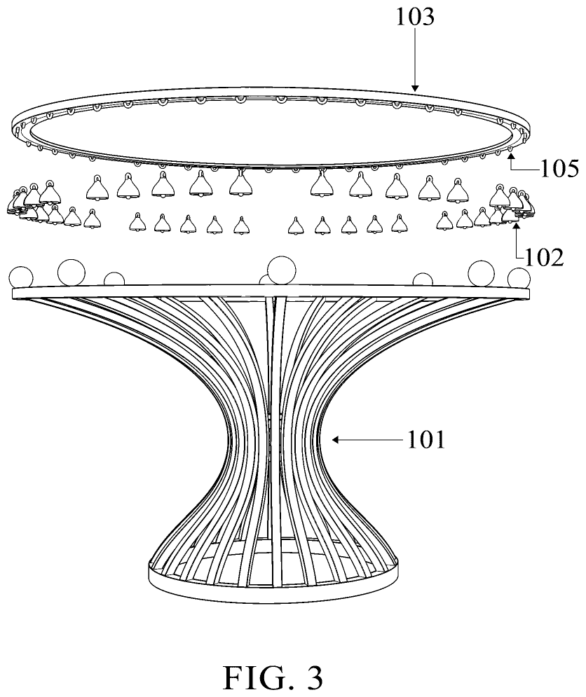

Referring to FIGS. 1-3, the furniture assembly includes a supporting base structure (101) and an upper structural portion (103) positioned above the supporting base structure (101), the two being separated by a defined structural space and together forming a load-bearing furniture unit configured to support functional loads.

The defined structural space is established as part of the structural design of the furniture assembly to accommodate the acoustic element and permit movement relative to adjacent load-bearing structural members in response to airflow interacting with the furniture assembly, while the supporting base structure (101) and upper structural portion (103) maintain their load-bearing function.

The suspension member (105) is formed as an integral structural feature of the structural frame assembly during manufacture and is permanently secured to the upper structural portion (103).

The acoustic element (102) is mechanically coupled to the suspension member (105) in a manner permitting oscillatory movement relative to the structural frame assembly within the structural space.

The suspension member (105) may include a rigid link, articulated linkage, chain, pivot joint, flexible connector, or equivalent coupling structure enabling multidirectional oscillatory movement relative to the structural frame assembly while remaining permanently secured to the upper structural portion (103).

Airflow interacting with the furniture assembly induces multidirectional oscillatory movement of the acoustic element (102) relative to the structural frame assembly.

The airflow-induced movement of the acoustic element relative to adjacent structural components produces audible sound through impact, resonance, vibration, or internal striker activation.

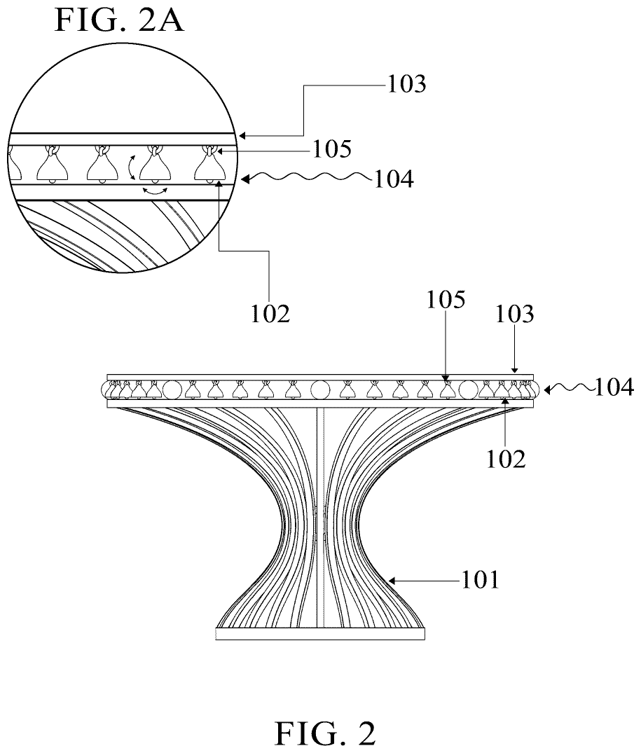

As illustrated in FIG. 2A, airflow interacting with the furniture assembly is represented by directional arrows (104) indicating the direction of airflow relative to the structural components. Curved directional arrows represent multidirectional movement including lateral swinging, rotational displacement, and compound motion about one or more axes resulting from airflow interaction.

The acoustic element may be arranged along the upper structural portion (103) in vertical rows, horizontal rows, circumferential distributions, linear arrangements, or other configurations.

The suspension member is permanently secured to the upper structural portion (103) as an integral structural component of the furniture assembly and is not configured for selective attachment or removal by an end user. The acoustic element is supported within the defined structural space such that the sound-producing system is structurally incorporated into the furniture assembly itself and is not an independently supported or separately mountable device.

Structural components of the furniture assembly may be fabricated from metal, wood, composite materials, polymers, or other load-bearing materials.

The furniture assembly may be configured as a table, seating structure, bench, shelving unit, console, pedestal, display stand, indoor furniture assembly, outdoor furniture assembly, or other load-bearing furniture form.

The acoustic element operates passively in response to airflow interacting with the furniture assembly and does not require electrical power, motorized actuation, or active control systems to generate audible sound.

In certain embodiments, multiple suspension members and multiple acoustic elements may be distributed within the structurally bounded space.

1. A wind-responsive furniture assembly comprising:
a structural frame configured to support functional loads;
at least one suspension member secured to the structural frame;
at least one acoustic element suspended from the at least one suspension member and positioned relative to the structural frame;
wherein airflow interacting with the structural frame induces multidirectional oscillatory movement of the at least one acoustic element relative to the structural frame; and
wherein oscillatory movement of the at least one acoustic element relative to the structural frame generates audible sound through mechanical interaction, the at least one acoustic element being structurally supported by and mechanically coupled to the structural frame such that the furniture assembly functions both as a load-bearing structure and as a passive airflow-actuated acoustic system.

2. The furniture assembly of claim 1, wherein the structural frame comprises a supporting base structure and an upper structural portion arranged in spaced relation.

3. The furniture assembly of claim 2, wherein the supporting base structure and the upper structural portion define a structurally bounded space within which the at least one acoustic element is positioned.

4. The furniture assembly of claim 3, wherein the structurally bounded space is at least partially open to ambient airflow.

5. The furniture assembly of claim 3, wherein the at least one acoustic element is positioned within the structurally bounded space at a location vertically offset from the supporting base structure.

6. The furniture assembly of claim 2, wherein the at least one suspension member is formed as an integral structural feature of the structural frame during manufacture.

7. The furniture assembly of claim 1, wherein the at least one acoustic element comprises a bell.

8. The furniture assembly of claim 1, wherein the at least one acoustic element comprises a tubular chime.

9. The furniture assembly of claim 1, wherein the at least one acoustic element includes an internal striker.

10. The furniture assembly of claim 1, wherein the at least one acoustic element is formed of metal, ceramic, composite materials, polymers, or combinations thereof.

11. The furniture assembly of claim 1, wherein a plurality of acoustic elements are arranged in vertical rows, horizontal rows, circumferential distributions, or linear configurations relative to the structural frame.

12. The furniture assembly of claim 1, wherein the at least one suspension member comprises a chain, articulated connector, flexible link, pivot joint, or rigid connector configured to permit multidirectional oscillation.

13. The furniture assembly of claim 2, wherein the upper structural portion comprises a continuous load-bearing frame member extending around a perimeter of the furniture assembly.

14. The furniture assembly of claim 1, wherein the furniture assembly is configured as a table, seating structure, bench, shelving unit, console, pedestal, display stand, or other load-bearing furniture article.

15. A wind-actuated furniture structure comprising:
a structural frame configured to support functional loads;
at least one acoustic element supported by the structural frame and positioned such that airflow interacting with the structural frame imparts movement to the acoustic element relative to the structural frame;
wherein movement of the acoustic element relative to the structural frame produces audible sound through mechanical interaction.

16. A method of generating audible sound using a wind-responsive furniture assembly, comprising:
providing a load-bearing furniture assembly including a structural frame;
securing at least one suspension member to the structural frame;
suspending at least one acoustic element from the suspension member such that the acoustic element is positioned relative to the structural frame;
exposing the furniture assembly to ambient airflow such that airflow interacting with the structural frame induces oscillatory movement of the acoustic element relative to the structural frame; and
generating audible sound through mechanical interaction resulting from the oscillatory movement.
